(19) United States
(12) Patent Application Publication
(10) Pub. No.: US 2008/0232822 A1
(43) Pub. Date: Sep. 25, 2008

(54) Optical receiver

(76) Inventors: Seigo Furudate, Yokohama-shi (JP); Shigenoshin Seto, Atsugi-shi (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/076,008

(22) Filed: Mar. 12, 2008

(30) Foreign Application Priority Data
Mar. 13, 2007 (JP) P2007-063861

(51) Int. Cl. H04B 10/06

(52) U.S. Cl. 398/202

(57) ABSTRACT

The present invention provides an optical receiver that suppresses the saturation in the output without alleviating the bandwidth restriction of the current-to-voltage conversion gain. This optical receiver comprises an amplifier 4 for receiving a photocurrent I_{IN} from a photodiode, and a plurality of trans-impedance elements connected in parallel between the input terminal and the output terminal of the amplifier 4. One trans-impedance element includes only resistor, while the other trans-impedance elements include semiconductor switches and resistors connected in series to the semiconductor switches so as to put the semiconductor switches therebetween.

### BACKGROUND OF THE INVENTION

1. Field of the Invention

The present invention relates to an optical receiver for receiving optical signals in an optical communication system.

2. Related Background Art

Optical receivers have been used for receiving optical signals in an optical communication system using optical fibers and the like. Such an optical receiver incorporates a trans-impedance amplifier therein, whereby a current signal output from a light-receiving device is converted into a voltage signal and amplified by pre-amplifier.

For example, Japanese Patent Application Laid-Open No. 2001-196877 discloses a circuit comprising trans-impedance amplifier connected to a light-receiving device with a plurality of feedback resistors interposed between the input and output terminals of the trans-impedance amplifier, and a plurality of switches each connected between a corresponding feedback resistors and the input terminal of the trans-impedance amplifier. This circuit varies the total feedback resistance by selecting the switches so as to adjust the current-to-voltage conversion gain. The above patent also discloses a combination of variable resistors as the feedback impedance and an amplifier able to change the open loop gain thereof. Such a circuit secures a gain for the small optical power, while, prevents saturation of an output in large optical power.

To control the gain and the bandwidth of the circuit by selecting feedback resistors as mentioned above may degrade the frequency bandwidth and increase the gain ripple, such as peaking, in the current-to-voltage conversion characteristic due to the capacitance of the switches which are typically configured with MOS transistors. The capacitance includes the stray capacitance of the interconnection coupled with the transistor and the junction capacitance of the transistor itself. Though the saturation in the output of the circuit may be suppressed by using variable resistors as the trans-impedance, switch to select the trans-impedance still accompany with their own parasitic components (parasitic capacitance and the like). Thus the output of the circuit cannot be escaped from the saturation and the band restriction.

In view of such a problem, it is an object of the present invention to provide an optical receiver with a function to control the current-to-voltage conversion gain, where the receiver can reduce the band restriction of the pre-amplifier circuit while suppressing the saturation in the output thereof.

### SUMMARY OF THE INVENTION

One aspect of the present invention relates to an optical receiver comprising a photodiode and an trans-impedance amplifier. The photodiode generates a photocurrent by receiving an input optical signal; and the trans-impedance amplifier converts this photocurrent into a voltage signal by a conversion gain. The trans-impedance amplifier includes an amplifier with an input terminal and an output terminal and a plurality of trans-impedance elements each connected in parallel with respect to the others between the input terminal and the output terminal. Each of trans-impedance elements is constituted of a semiconductor switching device and resistors connected in series to the semiconductor switching device so as to put the semiconductor switching device therebetween.

In another aspect of the trans-impedance amplifier of the present invention comprises an amplifier unit for inputting the photocurrent from photodiode; and a plurality of trans-impedance elements each connected in series with respect to each other between the input terminal and the output terminal of the amplifier unit. At least one of trans-impedance elements includes a parallel circuit constituted of a first resistor and a semiconductor switching device. In the present invention, the semiconductor switching device is indirectly connected to the input terminal and the output terminal of the amplifier unit through the first resistor of the trans-impedance element.

When the trans-impedance amplifier including the amplifier unit and the trans-impedance elements is viewed from its input terminal or its output terminal, resistors are arranged such that a semiconductor switching device is viewed beyond the resistor. Consequently, in a function where the semiconductor switch device changes the total trans-impedance, the capacitance of the semiconductor switching device is not directly appeared in the input terminal and the output terminal of the amplifier, which can effectively reduce the peaking and the bandwidth restriction of the trans-impedance amplifier.

Preferably the semiconductor switching device is a MOS transistor.

### BRIEF DESCRIPTION OF THE DRAWINGS

FIG. 1 is a circuit diagram showing the optical receiver in accordance with a first embodiment of the present invention;

FIG. 2 is a circuit diagram of a configuration of a trans-impedance element different from the trans-impedance element illustrated in FIG. 1;

FIG. 3 is a circuit diagram of still another configuration of a trans-impedance element different from the trans-impedance element illustrated in FIG. 1;

FIG. 4 is a circuit diagram, a portion of which is expressed by an equivalent circuit, for explaining an operation of the optical receiver in accordance with the first embodiment;

FIG. 5 is a circuit diagram showing the optical receiver in accordance with a second embodiment of the present invention; and

FIG. 6 is a circuit diagram showing a modified example of trans-impedance element of FIG. 5.

### DESCRIPTION OF THE PREFERRED EMBODIMENTS

In the following, preferred embodiments of the optical receiver in accordance with the present invention will be explained in detail with reference to the drawings. In the explanation of the drawings, the same or equivalent elements will be referred to with the same numerals or symbols without their overlapping descriptions.

### First Embodiment

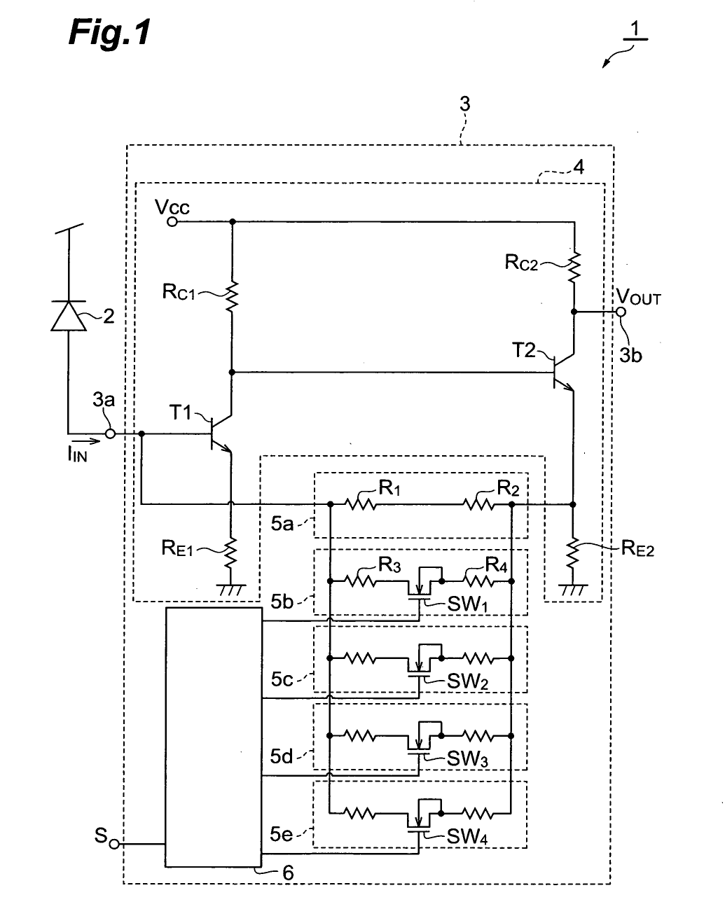

FIG. 1 is a circuit diagram showing the optical receiver 1 in accordance with the first embodiment of the present invention. As shown in FIG. 1, the optical receiver 1 comprises a PD (light-receiving device) 2, such as avalanche photodiode or PIN photodiode, which receives an input optical signal from the outside and generates a photocurrent I_{IN} in response to the input optical signal and a trans-impedance amplifier 3, which is connected to the anode of the PD 2, configured to convert the photocurrent I_{IN} generated by the PD 2 into a voltage signal, and to amplify thus converted voltage signal to generate an output voltage V_{OUT}.

Specifically, the trans-impedance amplifier 3 is constituted by an amplifier 4 connected between its input terminal 3a and output terminal 3b, a plurality of trans-impedance elements 5a to 5e connected in parallel to the amplifier 4 between the input terminal 3a and output terminal 3b, and a controller (control circuit) 6 connected to the trans-impedance elements 5b to 5e.

The amplifier 4 includes two transistors, T1 and T2, and resistors, R_{C1}, R_{C2}, R_{E1}, and R_{E2}. The transistor T1 has a base connected to the anode of the PD 2 through the input terminal 3a, a collector to which a bias voltage V_{CC} is applied through the resistor R_{C1}, and an emitter grounded through the resistor R_{E1}. The transistor T2 has a base connected to the collector of the transistor T1, a collector to which the bias voltage V_{CC} is applied through the resistor R_{C2}, and an emitter grounded through the resistor R_{E2}. The output terminal 3b is connected to the collector of the transistor T2. Such a configuration generates the output voltage V_{OUT} in response to an increase/decrease of the input photocurrent I_{IN}.

A plurality of trans-impedance elements, 5a to 5e, are connected in parallel to each other between the base of the transistor T1 and the emitter of the transistor T2, i.e., trans-impedance elements, 5a to 5e, and the transistors, T1 and T2, are held between the input terminal 3a and the output terminal 3b. The trans-impedance element 5a has a configuration where two resistors, R₁ and R₂, are connected in series. On the other hand, the trans-impedance element 5b includes a semiconductor switch SW₁ and two resistors, R₃ and R₄, which are connected in series to the semiconductor switch SW₁ so as to put the semiconductor switch SW₁ therebetween. The trans-impedance elements, 5c to 5e, have similar configuration where series resistors are connected so as to put the semiconductor switches SW₂ to SW₄ therebetween. Namely, among the trans-impedance elements, 5a to 5e, those except for the first trans-impedance element 5a have the configuration where the semiconductor switches, SW₁ to SW₄, are put between respective resistors. MOS transistors are preferably applicable to the semiconductor switches, SW₁ to SW₄ by a reason that they can be integrated in an IC.

The feedback resistor constituted by the plurality of trans-impedance elements, 5a to 5e, constitutes a negative feedback loop on the amplifier 4 with their total resistance. Therefore, the total resistance of the trans-impedance elements, 5a to 5e, determines the current-to-voltage conversion gain in the trans-impedance amplifier 3. For example, the current-to-voltage conversion gain becomes greater and smaller as the total feedback resistance is greater and smaller, respectively.

The controller 6 is connected to the control terminals of the respective semiconductor switches, SW₁ to SW₄. Responding to a control signal S provided from the outside, the controller 6 selectively turns on/off the semiconductor switches, SW₁ to SW₄. Specifically, a 2-bit digital signal is provided as the control signal S from the outside. The controller 6 turns on one of or a combination of switches, SW₁ to SW₄, in response to the control signal S, thereby selectively connecting two resistors accompanied with the target switch to each other. Such a function of the controller 6 makes the total trans-impedance selectable in step-like in response to the control signal S.

Operations of the optical receiver 1 explained in the foregoing will now be explained as comparing with examples.

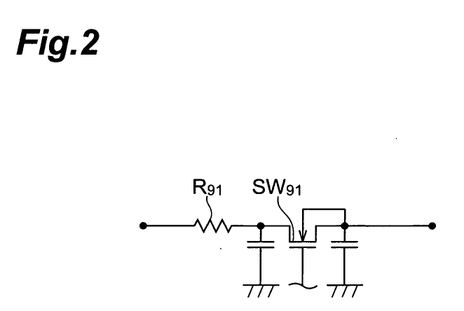

Though the trans-impedance elements, 5b to 5e, configure with the semiconductor switches, SW₁ to SW₄, each put between two resistors in the optical receiver 1, another configuration where one resistor R₉₁ is connected to the input side of a semiconductor switch SW₉₁ as shown in FIG. 2 may be applicable. This configuration, because the stray capacitance inherently appears at the source and the drain of the semiconductor switch SW₉₁ in addition to junction capacitance thereof, is equivalent to a configuration where this capacitance is connected in parallel to the resistor R_{E2} of the transistor T2. Therefore, the current amplification factor of the transistor T2 changes depending on an input signal, exactly the frequency of the input signal, whereby the degradation of the frequency response such as peaking may occur in the output of the amplifier.

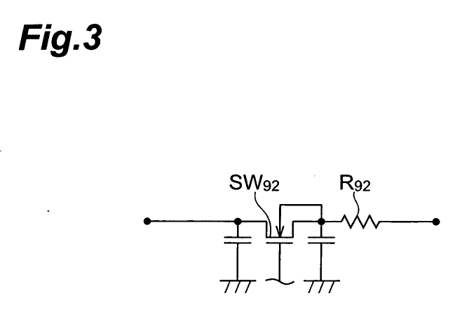

A configuration where one resistor R₉₂ may be connected to the output side of the semiconductor switch SW₉₂ is shown in FIG. 3. Observing from the input terminal of the trans-impedance amplifier 3 in this case, the input capacitance increases by the parasitic and the junction capacitance of the semiconductor switch SW₉₂, thereby deteriorating the frequency bandwidth of the trans-impedance amplifier 3. Though the feedback resistance may be set smaller in order to suppress the bandwidth degradation, this technique will lower the sensitivity of the trans-impedance amplifier 3.

In the trans-impedance element 5b by contrast, the semiconductor switch SW₁ is connected to the input terminal 3a and output terminal 3b of the trans-impedance amplifier 3 not directly but through the resistors, R₃ or R₄. This can suppress the influence of the capacitance attributed to the semiconductor switch SW₁ placed on the input or the output of the amplifier. Namely, this can effectively prevent the peaking and the bandwidth restriction of the trans-impedance amplifier 3.

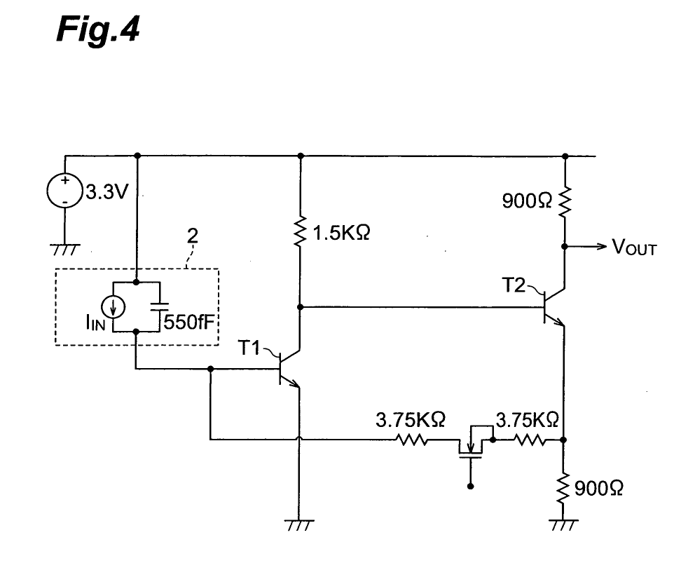

Table 1 shows the simulations of the conversion gain, the bandwidth, and whether the peaking exists or not of the optical receiver 1. The case “Divisionally arranged resistor” in Table 1 simulated each characteristic in the equivalent circuit shown in FIG. 4. Specifically, the PD 2 was expressed by a parallel circuit of a current source I_{IN} and a capacitor having a capacitance of 550 fF, the bias voltage V_{CC} was 3.3 V, the resistor connected to the transistor T1 was 1.5 kΩ, each resistors connected to the collector and the emitter of the transistor T2 were 900Ω, and the trans-impedance element had a configuration in which a MOS transistor in the on state was inserted between two resistors each having a resistance of 3.75 kΩ. The case “No MOS transistor” assumed a case without MOS transistor in the trans-impedance element of FIG. 4. The case “MOS transistor on output side” assumed a case where the MOS transistor was directly arranged on the output side, namely, the resistor in the output side was short-circuited and the resistor in the input side was doubled. The case “MOS transistor on input side” assumed a case where the MOS transistor was directly arranged on the input side, namely, the resistor in the input side was short-circuited and the resistor in the output side was doubled. Whether there was any peaking or not was determined whether the frequency response of the amplifier shows any rising in high frequencies compared to the response in low frequencies, particularly around the cut-off frequencies of the amplifier, and the bandwidth was determined by the frequency where the response decreased by 3 dB with respect to that in the low frequencies.

TABLE 1

| | CONNECTION MODE | | | |
|---|---|---|---|---|
| | | | | DIVISIONALLY |
| | NO MOS | MOS TRANSISTOR | MOS TRANSISTOR | ARRANGED |
| CHARACTERISTIC | TRANSISTOR | ON OUTPUT SIDE | ON INPUT SIDE | RESISTOR |
| CONVERSION GAIN | 78.1 dB Ω | 78.3 dB Ω | 78.3 dB Ω | 78.3 dB Ω |
| BANDWIDTH | 1.13 GHz | 1.92 GHz | 1.07 GHz | 1.20 GHz |
| PEAKING | NO | 0.95 dB | NO | NO |

These results show that the peaking appears when the MOS transistor is arranged on the output side and the bandwidth reduction occurs when the MOS transistor is arranged on the input side. These degradation are suppressed by arranging the resistors divisionally at both ends of the MOS transistor. Therefore, such a structure in which trans-impedance elements are connected in parallel is advantageous when the trans-impedance elements are selected from a plurality of feedback resistors by the MOS transistors.

### Second Embodiment

The second embodiment of the present invention will now be explained.

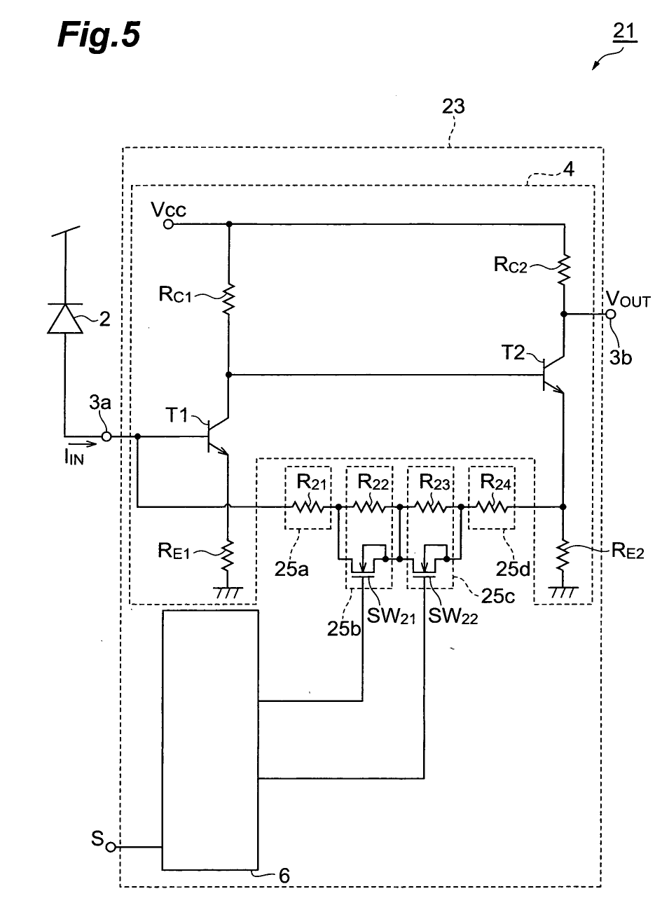

FIG. 5 is a circuit diagram showing the optical receiver 21 in accordance with the second embodiment of the present invention. The optical receiver 21 shown in FIG. 5 differs from the foregoing optical receiver 1 by a configuration of the trans-impedance element.

Specifically, the amplifier 23 includes a plurality of trans-impedance elements, 25a to 25d, connected in series to each other such that these trans-impedance elements 25a to 25d are held between the input and the output of the amplifier. Among these trans-impedance elements, the trans-impedance elements 25a and 25d directly connected to the input and the output include respective resistors, R₂₁ and R₂₄. On the other hand, the other trans-impedance elements, 25b and 25c, connected to the input and the output through other impedance elements have respective resistors, R₂₂ and R₂₃ and respective semiconductor switches, SW₂₁ and SW₂₂, connected in parallel to the resistors, R₂₂ and R₂₃. Thus, the impedance elements, 25b and 25c, not directly connected to the input or the output have a configuration where a resistor and a switch device are connected in parallel. This provides resistors connected in series to the semiconductor switches, SW₂₁ and SW₂₂, between the input and the semiconductor switch SW₂₁, and between the output and the semiconductor switch SW₂₂, respectively.

The controller 6 is connected to the gate of the respective semiconductor switches, SW₂₁ and SW₂₂. By setting a control signal S, the controller 6 selectively turns on/off the semiconductor switches, SW₂₁ and/or SW₂₂, thereby short-circuiting the resistors, R₂₂ and/or R₂₃. Thus, the total impedance of the trans-impedance elements, 25a to 25d, is controlled in step-like.

Such an optical receiver 21 can also suppress the influence of the capacitance of the semiconductor switches, SW₂₁ and SW₂₂, set on the input or output side. Namely, this configuration of the trans-impedance elements can effectively prevent the peaking and the bandwidth restriction in the frequency response of the trans-impedance amplifier 23.

Tables 2 to 4 show simulations of the current-to-voltage conversion gain and the bandwidth of the trans-impedance amplifier 21. Tables 2 to 4 simulated in a high-speed mode (where both of the semiconductor switches, SW₂₁ and SW₂₂, turn on), in a medium-speed mode (where the semiconductor switches, SW₂₁ and SW₂₂, turn off and on, respectively), and in a low-speed mode (where both of the semiconductor switches, SW₂₁ and SW₂₂, turn off), respectively. Specifically, the PD 2 was replaced with a parallel circuit of a current source I_{IN} and a capacitor with capacitance of 435 fF, the bias voltage V_{CC} was 3.3 V, the resistor connected to the collector of the transistor T1 was 200Ω, each of the resistors connected to the collector and the emitter of the transistor T2 was 130Ω, and the resistors, R₂₁ to R₂₄, in the trans-impedance elements were 700Ω, 700Ω, 2100Ω, and 700Ω, respectively. In each of Tables 2 to 4, the case “No resistance on input side” assumes a configuration where the resistor R₂₁ is removed and the resistance of the resistor R₂₄ is doubled, while the case “No resistance on output side” assumes a case where the resistor R₂₄ is removed and the resistance of the resistor R₂₁ is doubled. These simulations indicate that the bandwidth deterioration caused by setting the MOS transistor switch in the input side or the output side is suppressed by configuring resistors on the input and the output sides, and that favorable performances are obtainable in the high-speed mode in particular. It is also found that the advantages aforementioned are similarly obtainable in the medium-speed mode, and that no adverse affects are appeared in the low-speed mode.

TABLE 2

| | CHARACTERISTIC | |
|---|---|---|
| | | C-V CONVERSION |
| CONNECTION MODE | BANDWIDTH | GAIN |
| EMBODIMENT | 3441 MHz | 1697 Ω |
| NO RESISTANCE | 2805 MHz | 1677 Ω |
| ON INPUT SIDE | | |
| NO RESISTANCE | 2835 MHz | 1719 Ω |
| ON OUTPUT SIDE | | |

TABLE 3

| | CHARACTERISTIC | |
|---|---|---|
| | | C-V CONVERSION |
| CONNECTION MODE | BANDWIDTH | GAIN |
| EMBODIMENT | 2523 MHz | 2120 Ω |
| NO RESISTANCE | 2383 MHz | 2107 Ω |
| ON INPUT SIDE | | |
| NO RESISTANCE | 2133 MHz | 2134 Ω |
| ON OUTPUT SIDE | | |

TABLE 4

| | CHARACTERISTIC | |
|---|---|---|
| | | C-V CONVERSION |
| CONNECTION MODE | BANDWIDTH | GAIN |
| EMBODIMENT | 1232 MHz | 3545 Ω |
| NO RESISTANCE | 1180 MHz | 3545 Ω |
| ON INPUT SIDE | | |
| NO RESISTANCE | 1233 MHz | 3545 Ω |
| ON OUTPUT SIDE | | |

The present invention is not limited to the above-mentioned embodiments. The trans-impedance elements connected in parallel to each other in the optical receiver 1 or the trans-impedance elements connected in series to each other in the optical receiver 21 are not limited to any specific number.

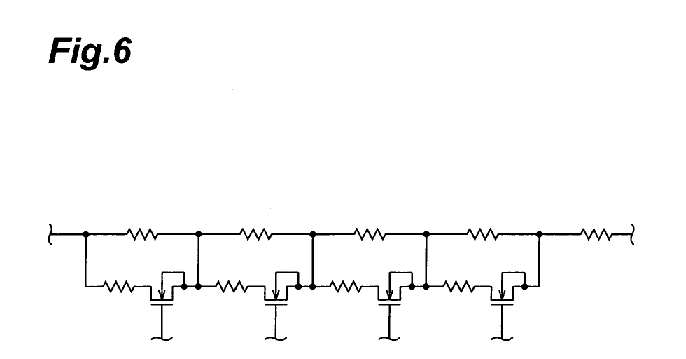

The trans-impedance elements of the optical receiver 21 may have a configuration shown in FIG. 6. Namely, the trans-impedance elements may include a plurality of elements each including parallel circuit of a semiconductor switch serially connected with a resistor and another resistor, and a resistor connected in series on the output side and one of the plurality of elements arranged closest to the output side. In this configuration, the trans-impedance element constituted by only a resistor connected between the input of the amplifier and the element arranged closest to the input is unnecessary.

Other switching devices such as bipolar transistors may also be applicable to the semiconductor switches, SW₁ to SW₄, SW₂₁ and SW₂₂ included in the trans-impedance elements, 5b to 5e, 25b and 25c.

What is claimed is:

1. An optical receiver comprising:
a photodiode to generate a photocurrent by receiving an optical input signal; and
a trans-impedance amplifier for converting said photocurrent into a voltage signal, said trans-impedance amplifier providing an amplifier unit and a plurality of trans-impedance elements each connected between an input terminal and an output terminal of said amplifier unit,
wherein each of said plurality of trans-impedance elements includes a semiconductor switching device and resistors serially connected to said semiconductor switching device so as to put said semiconductor switching device therebetween.

2. The optical receiver according to claim 1,
wherein said trans-impedance amplifier further includes feedback resistor connected between said input terminal and said output terminal of said amplifier unit, said feedback resistor being configured in parallel to said plurality of trans-impedance elements.

3. The optical receiver according to claim 1,
wherein said semiconductor switching device is a MOS transistor.

4. An optical receiver, comprising:
a photodiode to generate a photocurrent by receiving an optical input signal; and
a trans-impedance amplifier for converting said photocurrent into a voltage signal, said trans-impedance amplifier providing an amplifier unit and a plurality of trans-impedance elements connected in serial with respect to each other between an input terminal and an output terminal of said amplifier unit,
wherein at least one of said trans-impedance elements includes a parallel circuit constituted of a first resistor and a semiconductor switching device, and
wherein said semiconductor switching device is indirectly connected to said input terminal and said output terminal of said amplifier unit through said resistor of said trans-impedance element.

5. The optical receiver according to claim 4,
wherein said semiconductor switching device accompanies with a second resistor serially connected thereto, and
wherein said parallel circuit is constituted of said semiconductor switching device with said second resistor and said first resistor.

6. The optical receiver according to claim 4,
wherein said semiconductor switching device is a MOS transistor.
